(19) United States
(12) Patent Application Publication
(10) Pub. No.: US 2020/0313525 A1
(43) Pub. Date: Oct. 1, 2020

(54) APPARATUS AND METHOD FOR FORMING A CONDUCTOR PACKET

(71) Applicant: Miba Automation Systems Ges.m.b.H., Laarkirchen (AT)

(72) Inventors: Andreas Falkner, Wels (AT); Mladen-Mateo Primorac, St. Pölten (AT); David Scherrer, Gmunden (AT)

(21) Appl. No.: 16/759,634

(22) PCT Filed: Oct. 25, 2018
(86) PCT No.: PCT/AT2018/060260

§ 371 Date: Apr. 27, 2020

(30) Foreign Application Priority Data
Oct. 30, 2017 (AT) A50903/2017

(51) Int. Cl. H02K 15/04; B21D 39/04

(52) U.S. Cl. CPC H02K 15/0428; B21D 39/046

(57) ABSTRACT

The invention relates to a device and method for forming a conductor pack provided for inserting into a stator or rotor, wherein the device in this regard comprises an inner holding device with receiving portions arranged along an outer circumference of the inner holding device and provided for receiving, at least in sections, first rod sections with first conductor ends of substantially U-shaped conductor elements, a positioning device for pre-positioning second rod sections with second conductor ends of the conductor elements, which second rod sections are connected to the first rod sections by a substantially arc-shaped connection section, at least one gripping device arrangeable around the inner holding device in the circumferential direction with gripping elements adjustable in the radial direction towards the inner holding device, said gripping device being formed for gripping rod section pairs, each formed from a pre-positioned second rod section and an adjacent, first rod section, and, in this regard, the receiving portions are dimensioned such that the first rod sections are rotatably receivable in the receiving portions at least in sections, and the positioning device, for pre-positioning the second rod sections, comprises a positioning element spaced apart from the inner holding device outwards in the radial direction, which positioning element is circumferentially drivable in the circumferential direction of the inner holding device and simultaneously adjustable radially inwards.

The invention relates to a device and method for forming a conductor pack provided for inserting into a stator or rotor.

As they constitute important functional components of an electric motor, its stator and/or rotor are usually formed from a plurality of electric conductor elements, which are arranged around an electromagnetically excitable core. In this regard, the conductor elements are arranged such that, for example, in a stator, a plurality of windings are formed, which cause the formation of an electromagnetic field when electrical current flows through them. For this purpose, U-shaped conductor elements are often inserted into stators and electrically interconnected in accordance with a predetermined interconnection pattern. Correctly positioning the U-shaped conductor elements, which often have different lengths, in the stator pack often requires substantial manual effort or may only be accomplished by means of sophisticated equipment.

For this purpose, DE 102014226224 A1 presents a method for forming U-shaped winding elements, wherein an inner and an outer tool component of a saw set are rotated against each other and, in this process, the winding elements are each gripped by one tooth, and a rod section of the winding element is deformed.

However, it would be advantageous to arrange the U-shaped conductor elements in a predeterminable position and to combine them into a conductor pack prior to inserting them into a stator or rotor. This object is achieved by the present invention by overcoming the disadvantages of the prior art, and a device and method are disclosed by means of which a user is able to easily form a conductor pack for inserting into a rotor or stator.

The method according to the invention for forming a conductor pack for inserting into a stator or rotor comprises the following steps
providing a plurality of substantially U-shaped conductor elements, each having a first rod section and a first conductor end and a second rod section and a second conductor end, which rod sections are connected by a substantially arc-shaped connection section,
receiving, at least in sections, the first rod sections in receiving portions, which receiving portions are formed along an outer circumference of an inner holding device,
pre-positioning of the second rod sections by placing a respective second rod section into the vicinity of a first rod section of another conductor element by means of a positioning device,
and gripping rod section pairs, each formed from a pre-positioned second rod section and a first rod section adjacent in the radial direction, by gripping elements of at least one gripping device circumferentially arranged around the inner holding device, said gripping elements being guided in the radial direction towards the inner holding device, wherein, prior to the pre-positioning of the second rod sections, the first rod sections are rotatably received in the receiving portions at least in sections, and the second rod sections are arranged annularly in a free-standing manner around the outer circumference of the inner holding device and spaced apart from the outer circumference outwards in the radial direction, and that, for pre-positioning, the second rod sections are pressed by means of a positioning element of the positioning device, said positioning element being guided in the circumferential direction and simultaneously in the radial direction towards the outer circumference of the inner holding device, wherein the conductor elements are each rotated around a first rod longitudinal axis of the first rod sections rotatably received in the receiving portions at least in sections.

By means of the method according to the invention, pre-positioning, i.e. alignment, of the U-shaped conductor elements in accordance with a predeterminable interconnection pattern is achieved in a relatively simple way. By guiding the positioning element, in accordance with the invention, in the circumferential direction and simultaneously moving it inwards in the radial direction, rotational movement of the conductor elements is carried out relatively easily. In the course of the pre-positioning, the first rod sections are, by means of the rotational movement and without a disadvantageous deformation of the conductor elements, directly adjacently arranged in the radial direction with provided second rod sections of another conductor element, thereby forming a rod section pair. Thus, a possible step of deforming the conductor element, which would usually result in a change in cross-section and thus in a change in resistance of the conductor element, is omitted. Applying or rotating the conductor elements by means of the positioning element may be carried out in one or several turns around the inner holding device.

In this regard, the first rod sections of the conductor elements are only in contact with the rod section in sections, i.e. with a longitudinal part of the rod section; this way, only small frictional forces occur at the conductor element. This is advantageous as the conductor elements are usually provided with an insulation, which should not be damaged when the rod sections are positioned for forming the rod section pairs or the conductor pack.

The described pre-positioning thus describes the formation of a conductor pack by means of which a subsequent process of gripping the conductor pack or a following process of transferring and/or inserting the conductor pack into a stator or rotor is considerably simplified.

Furthermore, it may be appropriate if during providing, receiving and pre-positioning, the conductor elements are each contacted at the first and the second rod sections by one lever, which is rotatably formed around the first rod longitudinal axis of the respective first rod sections, and the levers, during pre-positioning, guide the second rod sections in the circumferential and radial directions through an inward pivotal movement, by analogy with the pressing movement of the second rod sections by the positioning element.

By using levers, process reliability may be increased as the second rod sections are guided in the radial and/or circumferential direction. This is advantageous especially in the case of relatively long U-shaped conductor elements.

In addition, it may be provided that during providing, receiving and pre-positioning, the conductor elements are each contacted at the second rod section by one guide groove of at least one link, and, during pre-positioning of the second rod sections, the second rod sections are guided in the circumferential and radial directions by the positioning element by means of the respective guide groove.

As with the use of levers, by guiding the second rod sections within a guide groove of a link, very precise positioning of the second rod sections at the provided first rod sections may be performed.

It is conceivable to arrange several links in the axial direction one above the other and thus provide multiple contact points on the second rod sections in the axial direction, which additionally secures the conductor elements against accidental tilting. This measure is especially advantageous in the case of very long conductor elements. Similarly, it is also conceivable to use both a lever and at least one link and a plurality of levers which are arranged one above the other in the axial direction.

Moreover, it may be provided that the positioning element is formed by a roller element rotatably arranged at the positioning device, and that said roller element, during pre-positioning of the second rod sections, rolls on the second rod sections or is actively driven to roll on the second rod sections.

Pressing of the second rod sections is achieved by rolling in a non-abrasive manner, which may efficiently prevent damage to the conductor elements or their insulation. Moving the positioning element towards the inner holding device may be completed within one turn or several turns. Pressing, i.e. pre-positioning of the second rod sections, may thus be performed very precisely, which may contribute to increasing the process reliability.

What is also advantageous is a type of method according to which it may be provided that the receiving portions for the first rod sections are formed by receiving grooves which are open outwards and run in the axial direction, and that the first rod sections are received in said receiving grooves at least in sections, wherein, during receiving of the first rod sections and during pre-positioning of the second rod sections, a sleeve is arranged around the first rod sections at least in sections, which sleeve directly adjacently surrounds the first rod sections outwards in the radial direction and, during pre-positioning, secures the first rod sections against being displaced outwards in the radial direction.

The sleeve is thus temporarily provided as a limitation of the first rod sections in the radial direction, by means of which tilting or outward displacement may be prevented. In this regard, the sleeve may be arranged contiguous with the first rod sections or divided from them by a small gap in order not to impede a rotational movement of the second rod sections. In this regard, the sleeve may advantageously be arranged below the inner holding device or the receiving portions.

According to a further development, it is possible to apply the second rod sections to an outer sleeve shell surface of the sleeve for pre-positioning. This may be advantageous during pre-positioning as the second rod sections are thereby positioned in close proximity to the provided first rod sections but are not yet in contact with them. By means of this intermediate step, second conductor sections that are perhaps not yet correctly aligned may be precisely aligned with respect to the first rod sections with an additional turn of the positioning element in the circumferential direction.

Moreover, it is appropriate that, after pre-positioning of the second rod sections, the sleeve is shifted in the axial direction with respect to the inner holding device downwards into an area of the second conductor ends of the second rod sections, and that afterwards, the second conductor ends of the pre-positioned second rod sections are pressed by means of the positioning element or the gripping elements of the gripping device into positioning grooves circumferentially arranged in an upper end area at the sleeve and open upwards.

By shifting the sleeve, the second rod sections may thus be uncovered with respect to the allocated first rod sections in the radial direction and be precisely applied to said first rod sections. Consequently, the rod section pairs formed in this way are substantially evenly distributed in the circumferential direction. The grooves of the receiving portions of the inner holding device may have a sufficient groove depth in the radial direction for receiving the rod section pair, or the positioning grooves provided at the sleeve may receive at least a lower area of the second conductor ends. This way, a shifting in the axial, radial and circumferential directions of the formed conductor pairs may be efficiently prevented.

In addition, it may be provided that, during pre-positioning of the conductor elements, the first conductor ends of the first rod sections are supported in the axial direction by means of a supporting device having at least one supporting surface.

This way, the conductor elements are particularly effectively prevented from accidentally sliding down in the axial direction. This also reduces the risk of the conductor elements becoming stuck during pre-positioning.

In addition, it may be provided that, during pre-positioning of the second rod sections, a first rod section of at least one of the conductor elements is mounted by means of at least one height-adjustable supporting surface of the supporting device in a height different from other conductor elements.

The supporting device may thus form different levels of supporting surfaces for the first conductor ends in the axial direction. This is particularly advantageous in the case of conductor elements of different lengths as they may be provided for bridging different distances between the grooves. Therefore, it is necessary to rotate individual second rod sections over a larger or smaller number of conductor elements to be able to correctly position the second rod section with a first rod section of a provided conductor element. Since at least individual supporting surfaces of the supporting device are height-adjustable in the axial direction, the conductor elements may thus be prevented from becoming stuck during pre-positioning.

According to a particular embodiment, it is possible that in the area of the first conductor ends of the first rod sections, a groove ring is arranged at whose groove ring circumference securement grooves are arranged, which are open outwards and vertical, and that first conductor ends of the first rod sections are introduced into said securement grooves prior to the pre-positioning of the second rod sections.

The arrangement of the groove ring in the axial direction lies below the inner holding device; this way, an additional, second contact surface is created for the first rod sections. The first rod sections may thus be secured against tilting in the radial direction at least at two points, at least in sections. This facilitates increased process stability.

The pre-positioning device according to the invention for forming a conductor pack for inserting into a stator or rotor comprises
an inner holding device with receiving portions arranged along an outer circumference of the inner holding device and provided for receiving, at least in sections, first rod sections with first conductor ends of substantially U-shaped conductor elements,
a positioning device for pre-positioning second rod sections with second conductor ends of the conductor elements, which second rod sections are connected to the first rod sections by a substantially arc-shaped connection section,
at least one gripping device arrangeable around the inner holding device in the circumferential direction with gripping elements adjustable in the radial direction towards the inner holding device, said gripping device being formed for gripping rod section pairs, each formed from a pre-positioned second rod section and an adjacent, first rod section. The pre-positioning device according to the invention is characterized in that
the receiving portions are dimensioned such that the first rod sections are rotatably receivable in the receiving portions at least in sections
and that the positioning device for pre-positioning the second rod sections comprises a positioning element spaced apart from the inner holding device outwards in the radial direction, which positioning element is circumferentially drivable in the circumferential direction of the inner holding device and simultaneously adjustable radially inwards.

By means of the pre-positioning device according to the invention, the method steps described above may be performed in a relatively simple way. By means of the described construction and arrangement of the individual components or sub-devices, it is possible to position a plurality of conductor elements according to a predeterminable interconnection pattern in such a way that a conductor pack is formed. This way, it becomes possible to accomplish comparably fast and precise pre-positioning of the conductor elements at low cost, which is relevant especially in the case of high quantities.

The receiving portions have at least one longitudinal extension in the axial direction, which allows contacting of the first rod sections at least in sections; this way, tilting during pre-positioning may be reduced. The configuration of the positioning element of the positioning device, which is drivable in the circumferential direction and adjustable inwards in the radial direction, has the advantage that the second rod sections may be easily aligned with respect to the first rod sections provided for this purpose by means of one or several circumferential movements of the positioning element.

In this regard, the positioning device and/or the gripping device may be shiftable in the axial direction to ensure that the method steps are performed in sequential order. In this regard, the gripping elements may be segmented and adjustable or shiftable in the radial direction with respect to the inner holding device. This way, after pre-positioning, the conductor pack may be easily temporarily secured, and afterwards, it may be transferred to an inserting station, or possible subsequent method steps may be performed; however, this will not be discussed here in detail.

Moreover, it may be appropriate if a lever guiding device having a number of levers corresponding to the number of conductor elements is formed, wherein the levers are bow-shaped with a predeterminable lever length and two lever arms, which are horizontally extended and point in the same direction, wherein the first lever arm comprises one respective first rod section receiving portion having a shape compatible with the first rod section of the conductor element, and wherein the second lever arm comprises one respective second rod section receiving portion having a shape compatible with the second rod section of the conductor element, and the levers are each rotatably mounted around a first rod section receiving portion axis, which is aligned with a respective first rod longitudinal axis of the respective first rod sections, and wherein the levers are distributed in the circumferential direction and offset in the axial direction such that all levers are pivotable inwards in the circumferential direction.

The configuration of the lever guiding device may be carried out in different ways, wherein only the pivotal movement of the levers in the circumferential direction must be freely performable. By forming the levers with respective rod section receiving portions for the first and the second rod sections, temporary guiding of the conductor elements during pre-positioning may be ensured. This way, precise alignment of the second rod sections with respect to the first rod sections provided for this purpose is facilitated, and the conductor elements are prevented from tilting.

In addition, it may be provided that a link having a number of guide grooves corresponding to the number of conductor elements is formed, wherein the guide grooves are arcuate, starting from an inner diameter facing the inner holding device, and formed as openings penetrating the link in the axial direction as well as in the circumferential and the radial directions.

This way, guiding the second rod sections during pre-positioning may be facilitated. The link may be formed as a link plate and constitute an independent or combined guide with the lever guiding device described above for the second conductor sections. In addition, the link may be shiftable in the axial direction and/or rotatable in the circumferential direction. This may facilitate aligning the link with respect to the inner holding device and providing the conductor elements at or in the inner holding device.

Moreover, it may be provided that the positioning element is formed by a roller element rotatably arranged at the positioning device, wherein said roller element is rotatably mounted without a drive or operatively connected to a drive member for actively driven rotation.

It is conceivable that the positioning element is formed as a wedge, a roller or a comparable pressing element. In any case, pre-positioning of the second rod sections may be accomplished by rolling or pressing in the radial and the circumferential directions in a non-abrasive manner, which may efficiently prevent damage to the conductor elements or their insulation. For example, electric motors may be used as drive members.

What is also advantageous is an embodiment according to which it may be provided that the receiving portions for the first rod sections are formed by receiving grooves which are open outwards and run in the axial direction, and that a sleeve is formed, which is arranged below the receiving grooves, wherein an inner sleeve diameter of the sleeve is selected such that the sleeve forms a limitation for the first rod sections outwards in the radial direction.

In this regard, the sleeve may be shiftable in the axial direction and thus only temporarily serve as a stop for the first rod sections in the radial direction. This way, tilting of the conductor elements is prevented, which may increase process reliability. The sleeve further comprises a radial outer contact surface, which may be used for temporarily applying the second rod sections. This allows applying the second rod sections to this contact surface first during pre-positioning before the sleeve is shifted and the second rod sections may be applied to the associated first rod sections. The accuracy of the pre-positioning process may thus be increased.

Furthermore, it may be appropriate if the sleeve comprises positioning grooves arranged in an upper end area in the circumferential direction and open upwards, which positioning grooves are formed for receiving the second conductor ends of the second rod sections.

In this regard, the positioning grooves may preferably run horizontally and originate from a front end of the sleeve. The depth of the positioning grooves may be selected such that reception of the second conductor ends may be performed at least in sections. In this regard, the sleeve should be shiftable in the axial direction. Pressing the second conductor ends into the positioning grooves provided for this purpose may be carried out with an additional turn of the positioning element or by the gripping device.

In addition, it may be provided that a guiding element with positioning grooves is formed, which positioning grooves are formed for receiving the second conductor ends of the second rod sections.

This variation may be performed as an alternative to a sleeve shiftable in the axial direction to allow temporary guiding of the second conductor ends in the axial, circumferential and/or radial directions.

In addition, it may be provided that a supporting device having at least one supporting surface is formed, which supporting device is provided for axially supporting the first rod sections.

During providing, pre-positioning and/or gripping of the conductor elements, the supporting device allows correct positioning of the conductor elements in the axial direction. This way, it is efficiently prevented that individual conductor elements accidentally slide down in the axial direction.

According to a particular embodiment, the supporting device may comprise at least one height-adjustable supporting surface.

The supporting device may, for example, be constructed from several ring- or disc-shaped elements serving as a stop for the first conductor ends in the axial direction. Therefore, the supporting device may be constructed in segments, wherein it may consist of at least two rings or discs having the same radius in the radial direction. In addition, in the circumferential direction, at least one of said rings is open in the axial direction at the positions provided for this purpose, while at least one of said rings or discs may comprise extensions in the axial direction. Such a construction of the supporting device allows providing, in the axial direction, associated supporting surfaces for the conductor elements of different lengths at the positions provided for this purpose in the circumferential direction. At least individual supporting surfaces of the supporting device are thus shiftable in the axial direction; this way, only selectable conductor elements may be shifted in the axial direction. This offers the advantage that for the necessary rotation of the second rod sections for correct pre-positioning with respect to the first rod sections provided for this purpose, the rotational movement in the circumferential direction is facilitated without adjacent conductor elements colliding with each other. This is particularly useful if different numbers of distances between the grooves are present, i.e. if, according to the interconnection pattern, individual conductor elements are provided for bridging shorter or longer distances with respect to conductor elements adjacent in the circumferential direction.

According to an advantageous further development, it may be provided that a groove ring is formed at whose groove ring circumference securement grooves are arranged which are open outwards and vertical, which securement grooves are formed for receiving, at least in sections, the first conductor ends of the first rod sections.

In this regard, the groove ring may serve as a stop for the first rod sections inwards in the radial direction. The groove ring thus provides, at least in sections, a second contact surface for the first rod sections. This way, the conductor elements may be easily prevented from tilting out of their vertical alignment along the axial direction.

For better understanding of the invention, the latter is explained in detail with reference to the following figures.

The following is shown in the figures in highly simplified, schematic representation:

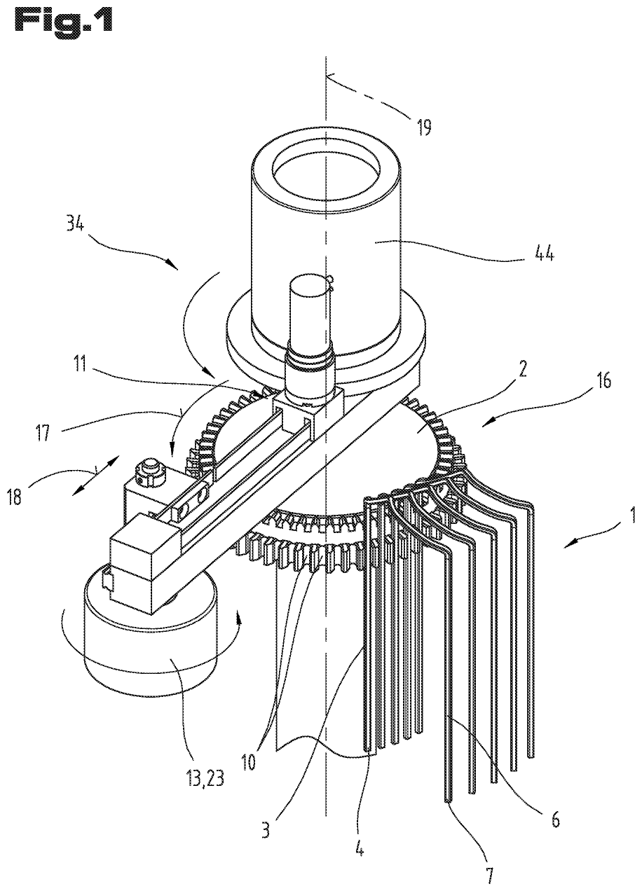

FIG. 1 embodiment of a pre-positioning device;

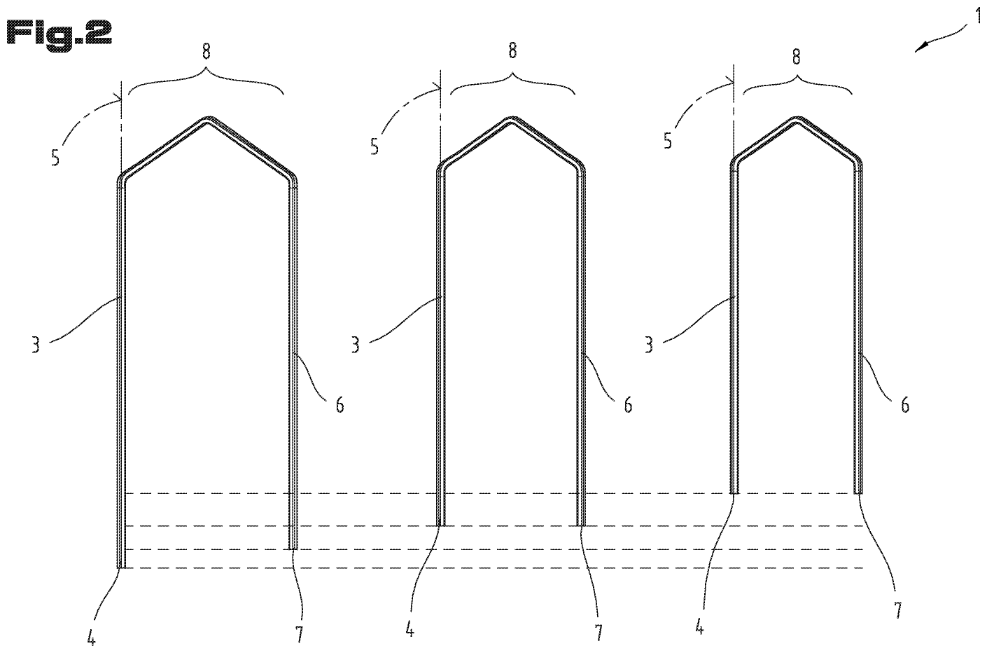

FIG. 2 examples of differently configured conductor elements;

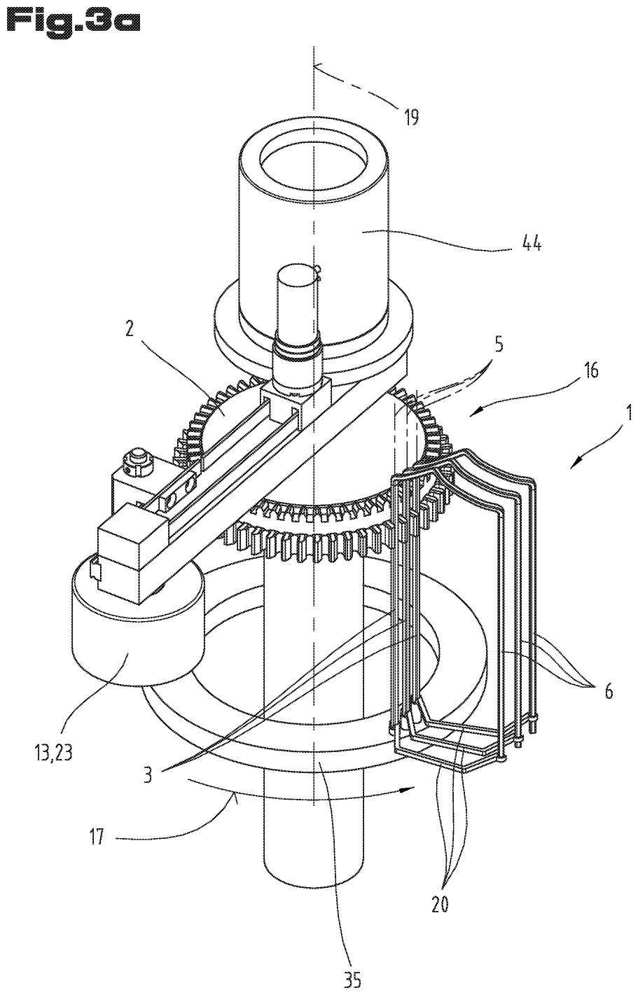

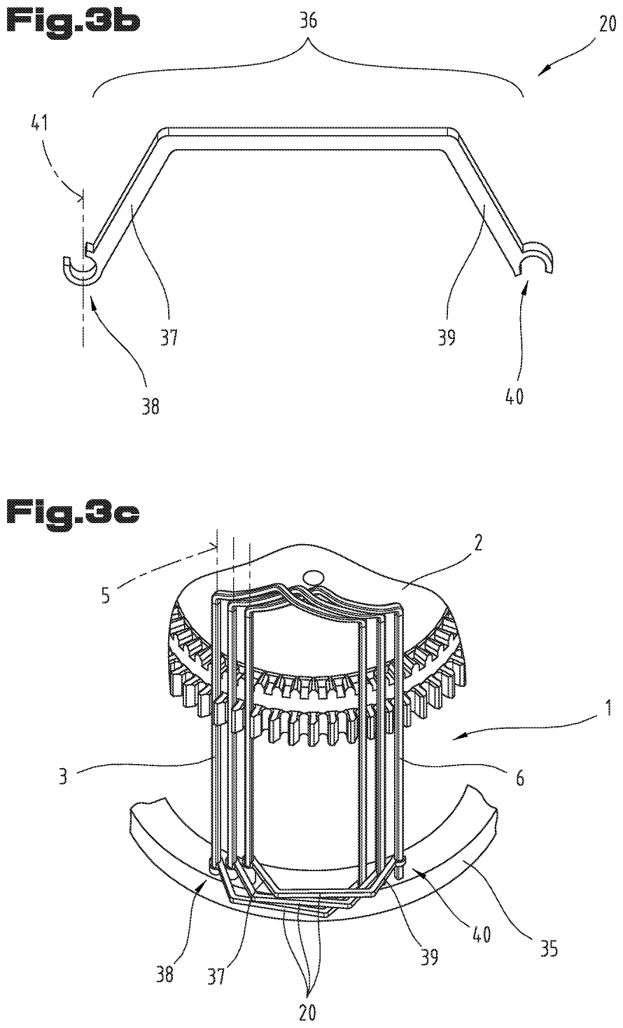

FIG. 3 excerpt from an embodiment of a pre-positioning device with a plurality of levers (a); example of a lever (b); enlarged excerpt from an embodiment where the levers have been pivoted inwards in the circumferential direction after pre-positioning;

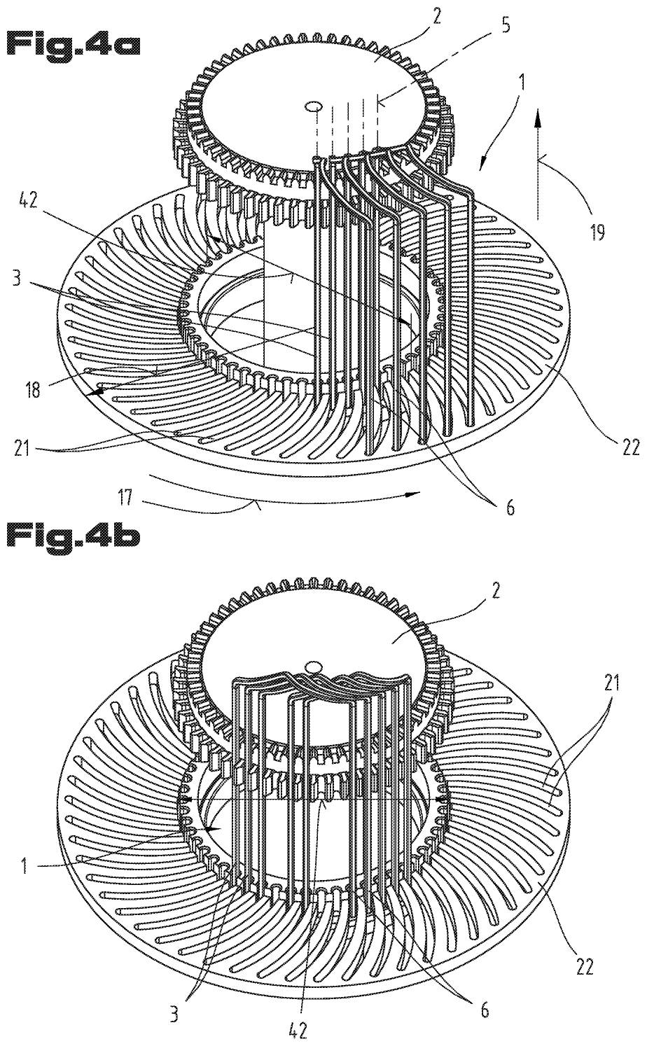

FIG. 4 excerpt from an embodiment of a pre-positioning device with a link and a plurality of guide grooves (a); enlarged excerpt from a link with pre-positioned second rod sections;

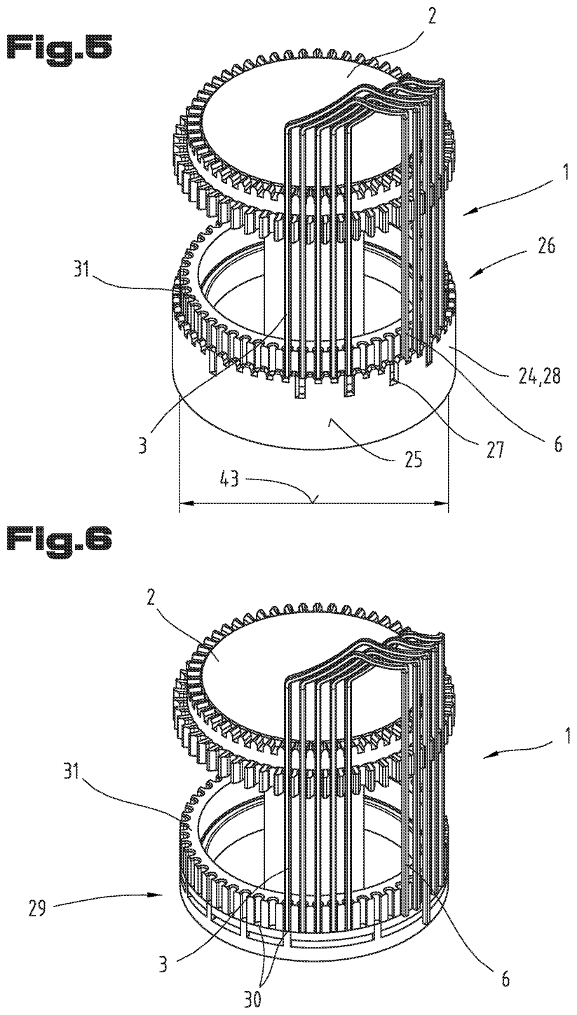

FIG. 5 excerpt from an embodiment of a pre-positioning device with a sleeve in an upper or lower position and a groove ring;

FIG. 6 excerpt from an embodiment of a pre-positioning device with a supporting device;

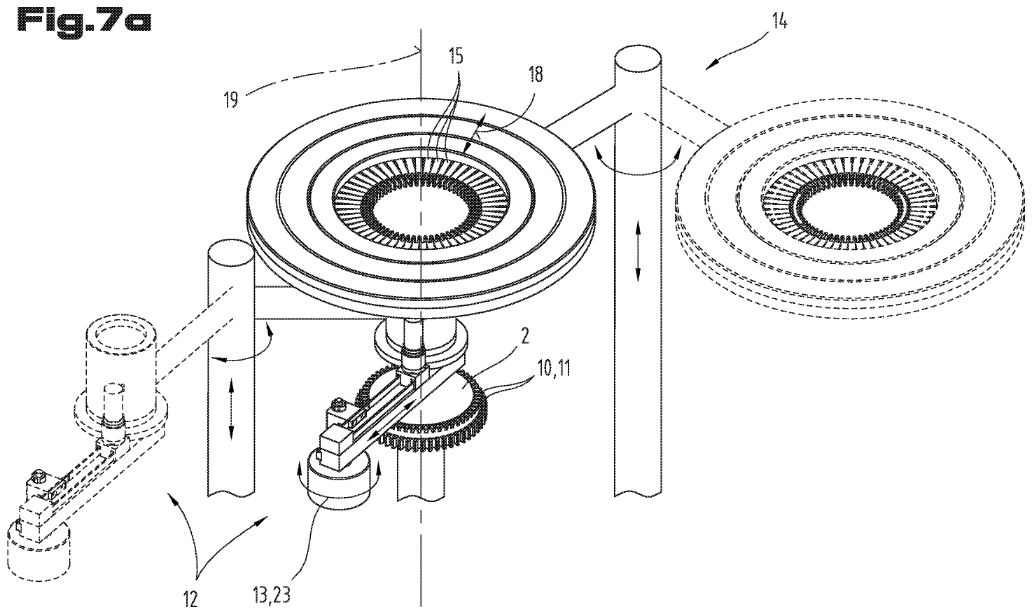

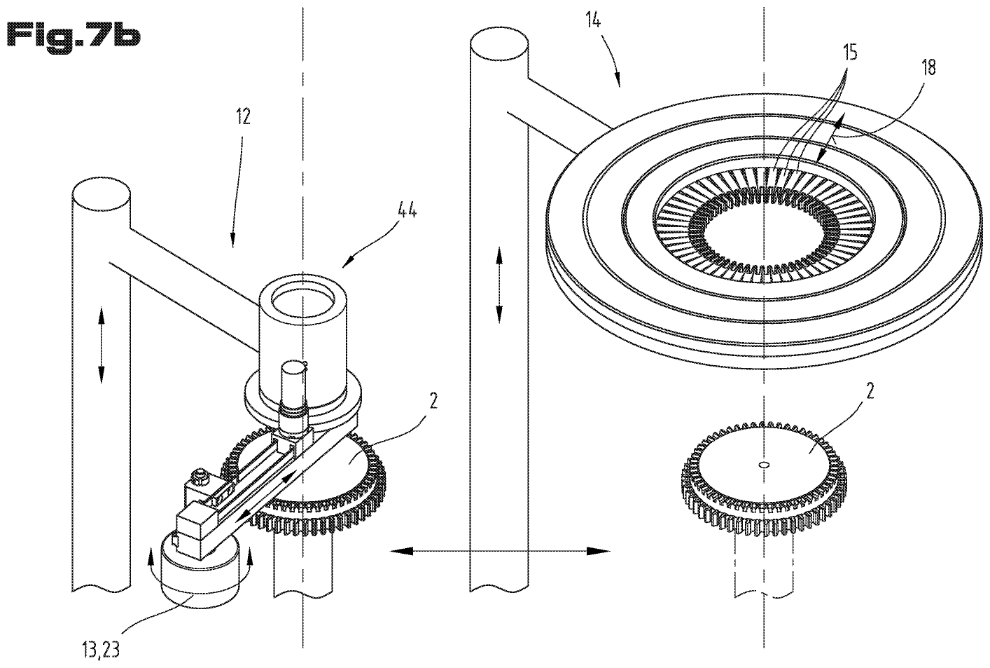

FIG. 7 embodiment of a pre-positioning device with a pivotable positioning device or gripping device (a), or with a shiftable inner holding device (b).

First of all, it should be noted that in the embodiments described in different ways, identical parts are given identical reference numbers or identical component names, and the disclosures contained in the entire description may be correspondingly applied to identical parts with identical reference numbers or identical component names. Moreover, the position indications used in the description, such as at the top, at the bottom, lateral, etc. directly refer to the figure shown and described, and, if a position changes, said position indications are to be correspondingly applied to the new position.

One embodiment of the pre-positioning device 34 according to the invention is shown in FIG. 1. The holding device 2 comprises a vertical main axis, which serves as the reference axis. The axial direction 19 is parallel to the vertical main axis of the inner holding device 2. The holding device 2 comprises an outer circumference 16, at which a plurality of receiving portions 10 can be seen. The receiving portions 10 may be configured as closed receiving portions 10 or, as shown in FIG. 1, as receiving grooves 11, in which the first rod sections 3 may be received at least in parts. For simplifying the representation, only five conductor elements 1 are shown.

Furthermore, in FIG. 1, a positioning device 12 is shown, which is arranged above the inner holding device 2 in the embodiment. In this regard, the positioning device 12 comprises a positioning element 13, which is shiftable or movable in the radial direction 18 and rotatably configured in the circumferential direction 17. Moreover, the positioning element 13 may be configured, for example, as a roller element 23, which is additionally rotatable around a vertical roller axis, as shown in FIG. 1. The positioning device 12 may further comprise a drive member 44, which may be provided for driving the positioning device 12 and/or the positioning element 13. It is also possible that additional drive members 44 are attached at the positioning device 11, the positioning element 13, and also at the holding device 2, for example in order to accomplish shifting of the positioning element 13 or the positioning device 12 relative to the inner holding device 2.

In FIG. 1 and particularly in FIG. 2, some examples of conductor elements 1 can be seen. The first and the second rod sections 3, 6 of a conductor element 1 are connected by a substantially arc-shaped connection section 8 and comprise a first 4 or second conductor end 7. Like the first and second rod sections 3, 6, said connection sections 8 may have different lengths, depending on the provided arrangement and thus on the distance to be bridged in the conductor pack to be formed. As shown in FIG. 2, conductor elements 1 with first or second rod sections 3, 6 of different lengths may be used. In addition, for the first rod section 3, a first rod longitudinal axis 5 can be seen, around which a rotational movement of the second rod section 6 is performed during pre-positioning.

For the pre-positioning process, different supporting elements may be used as a kind of alignment aid. In FIG. 3 and FIG. 4, the use of a lever guiding device 35 or a link 22 is shown by way of example.

The lever guiding device 35 in FIG. 3a comprises a number of levers 20 corresponding to the number of conductor elements 1, which levers are each couplable with the first and the second rod section 3, 6 of a conductor element 1. Such a lever 20 is schematically shown in FIG. 3b. Each lever 20 comprises at least one first rod section receiving portion 38, which is intended for temporarily connecting with at least one section of a first rod section 3. The first rod section receiving portion 38 comprises a first rod section receiving portion axis 41, which runs along the receiving portion opening and is thus normally oriented towards the longitudinal extension of the lever 20. When the levers 20 are used, said rod section receiving portion axis 41 meets the first rod longitudinal axis 5 of the conductor elements 1 during pre-positioning. This means that a joint rotation axis is formed, around which the respective second rod section 6 is rotated. Each lever 20 further comprises a first lever arm 37 or a second lever arm 39, wherein the two lever arms 37, 39 are connected with each other through connecting paths. The entire length of a lever 20 may correspond to the predetermined position of the conductor element 1 and thus to the length of the connecting section 8 of the assigned conductor elements 1, and is accordingly selected by the person skilled in the art. The levers 20 in FIG. 3a-c further comprise a second rod section receiving portion 40, which is provided for temporarily receiving and especially guiding the second rod sections 6.

The state prior to pre-positioning is symbolically shown in FIG. 3a. In this regard, the provided conductor elements 1 are arranged in the inner holding device 2 with their first rod sections 3. In the represented form, the levers 20 are positioned relatively close to the respective conductor ends 4, 7. The levers 20 may also be arranged along the rod longitudinal axis 5 in the axial direction 19 at other positions, preferably offset from each other. However, the levers 20 should be prevented from colliding during pre-positioning. A simple variation is shown in FIG. 3a, wherein the lever guiding device 35 is shown, for example, as a disc with rotatably mounted spacer sleeves to the individual levers 20. Of course, the levers 20 may be arranged in a different way by the person skilled in the art, or connection sections of the individual levers 20 of different shapes may even be used. It is crucial to allow unimpeded pivotal or rotational movement of the levers 20 or the conductor elements 1 in the circumferential direction 17 to position the second rod sections 6 at the provided first rod sections 3 of another conductor element 1. A final state after pre-positioning that may thus be achieved can be seen in FIG. 3c. The person skilled in the art clearly understands that in this regard, the levers 20 ensure guiding of the second rod sections 6, which allows exact positioning. Subsequent process steps of gripping, transferring and/or inserting are not explained here in detail.

By analogy with FIG. 3a and FIG. 3c, the use of a link 22 with guiding grooves 21 can be seen from FIG. 4a and FIG. 4b. However, for simplifying the representation, only some conductor elements 1 are shown. FIG. 4a shows the state prior to pre-positioning, in which providing of the conductor elements 1 can be seen. By means of the rotational movement of the positioning device 12 during pre-positioning, the second rod sections 6 are rotated along the guiding grooves 21 to their provided first rod sections 3 of another conductor element 1. As shown in FIG. 4a and FIG. 4b, the guide grooves 21 of the link 22 are formed as openings continuously extending in the axial direction, which are arcuate in the circumferential 17 and radial directions 18 from an inner diameter 42 facing the inner holding device 2. In FIG. 4b, a preliminary end position after pre-positioning of the second rod sections 6 is shown.

In FIG. 5, an example of an inner holding device 2 with some conductor elements 1 is shown. Furthermore, a sleeve 24 can be seen, which is shiftable in the axial direction 19 at least up to an upper position corresponding to a flush closure of the upper end area 26 of the sleeve 24 with the upper side of the inner holding device 2. The inner sleeve diameter 43 may be selected such that the first rod sections 3 are prevented from falling out by the sleeve 24 in the radial direction 18. This way, during pre-positioning, i.e. during the inward pivotal movement of the second rod sections 6 in the circumferential 17 and the radial directions 18 to the first rod sections 3, the second rod sections 6 may, for example, be applied to the sleeve shell surface 25 of the sleeve 24. In the representation chosen in FIG. 5, the sleeve 24 is in a lower position; this way, the second rod sections 6 are freely movable and may thus be applied flush with the first rod sections 3. As can be further seen in FIG. 5, the sleeve 24 may comprise positioning grooves 27 in the upper end area 26, which run outwards in the radial direction 18 and are open upwards in the axial direction 19. Said positioning grooves 27 may serve for receiving the second conductor ends 7 of the second rod sections 6 and may therefore have different groove depths in the axial direction 19, corresponding to the individual length of the second rod sections 6.

Moreover, embodiments are shown by way of example in FIG. 5 and FIG. 6 which comprise a groove ring 31 with a groove ring circumference 32. At the groove ring 31, securement grooves 33 are arranged, which are open outwards in the radial direction 18 and vertical. The groove ring 31 may, for at least temporarily supporting the first rod sections 3, be shiftable in the securement grooves 33 in the axial direction 19 and is preferably arranged in the area of the first conductor ends 4 in this regard.

As an alternative to a shiftable sleeve 24 in FIG. 5, a guiding element 28 with positioning grooves 27 may be provided. By analogy with the positioning grooves 27 of the sleeve 24, the positioning grooves 27 serve for receiving the second conductor ends 7 of the second rod sections 6 for facilitating temporary guiding of the second conductor ends 7 in the axial 19, circumferential 17 and/or radial directions 18. At this point, no separate representation of such a guiding element 28 is made, and reference is made to FIG. 5.

In FIG. 6, an embodiment is shown which shows a supporting device 29 with a plurality of supporting surfaces 30, which are horizontal. Said supporting surfaces 30 serve for supporting the first rod sections 3 in the axial direction 19. The supporting device 29 shown comprises a disc element, which is divided several times in the circumferential direction 17 and serves as a stop for the first conductor ends 4 in the axial direction 19. In addition, in the circumferential direction 17, said disc element is open in the axial direction 19 the positions provided for this purpose, and at said positions, extensions of a further disc element arranged below in the axial direction 19 can be seen. This way, in the exemplary representation, all first conductor ends 4 are temporarily kept at the same vertical position. The construction of the supporting device 29 may thus be accordingly adapted such that, in the axial direction 19, associated supporting surfaces 30 are provided for the conductor elements 1 of different lengths at positions provided for this purpose in the circumferential direction 17. In this regard, a distance between the two disc elements of the supporting device 29 which are shown in FIG. 6 can be seen, which may be reduced when one of the two disc elements is shifted in the axial direction 19; this way, at least individual supporting surfaces 30 of the supporting device 29 are shiftable in the axial direction 19. This way, only selectable conductor elements 1 may be shifted or lifted in the axial direction. The second rod sections 6 shown in FIG. 6 have been rotated in the circumferential direction 17 for correct pre-positioning with respect to the first rod sections 3 provided for this purpose without adjacent conductor elements 1 colliding with each other. Bridging of different distances by the respective conductor elements 1 to the correct positioning in accordance with the interconnection pattern can be easily understood with the example of the “longer conductor element” in FIGS. 5 and 6. After pre-positioning, the height-adjustable supporting surface 30 of the extensions of the lower disc element may, for example, be lowered to the same height position of the other supporting surfaces 30 of the upper disc element.

According to the present invention, it is conceivable that both the positioning device 12 and the gripping device 14 may be pivotable or movable, as schematically shown in FIG. 7a. In this regard, the positioning device 12 and/or the gripping device 14 are preferably shiftable in the axial direction 19.

Furthermore, an alternative arrangement of the positioning device 12 and of the gripping device 14 is conceivable, according to which the inner holding device 2 is shiftable and/or height-adjustable with respect to the stationarily arranged positioning device 12 and the gripping device 14. Such an exemplary variation is shown in FIG. 7b. In this regard, the basic functions and movement possibilities of the pre-positioning device 34 are not influenced by the arrangement of the individual sub-devices.

As shown in FIGS. 7a and 7b, the gripping device 14 may comprise gripping elements 15 shiftable in the radial direction 18. In this regard, the gripping elements 15 are formed such that they may at least temporarily secure the conductor elements 1 after pre-positioning, and that the adjusted position of the first and second rod sections 3, 6 is thus no longer changed during a possible transfer or insertion into a rotor or stator. The person skilled in the art is aware of different embodiments of such gripping elements 15; however, for the present invention, using link-guided and segmented gripping elements 15 is particularly advantageous.

The embodiments show possible variations; however, it should be noted at this point that the invention is not limited to its variations specifically shown; rather, various combinations of the individual variations are possible, and this variation possibility based on the technical teaching of the present invention is subject to the skills of the person skilled in the art active in this technical field.

The scope of protection is determined by the claims. However, the description and the drawings are to be used for construing the claims. The individual features or feature combinations of the different embodiments shown and described may constitute independent inventive solutions. The object underlying the independent inventive solutions may be gathered from the description.

All indications of ranges of values in the present description are to be understood such that they also include any and all sub-ranges therefrom; for example, the indication 1 to 10 is to be understood such that all sub-ranges are included, starting at the lower limit 1 up to the upper limit 10; i.e. all sub-ranges start with a lower limit of 1 or larger and end at an upper limit of 10 or less, e.g. 1 to 1.7, or 3.2 to 8.1, or 5.5 to 10.

As a matter of form, it should finally be noted that for better understanding of the structure, some of the elements have been represented unscaled and/or enlarged and/or in reduced size.

List of reference numbers

| | |
|---|---|
| 1 | conductor element |
| 2 | holding device |
| 3 | first rod section |
| 4 | first conductor end |
| 5 | first rod longitudinal axis |
| 6 | second rod section |
| 7 | second conductor end |
| 8 | connection section |
| 9 | rod section pair |
| 10 | receiving portions |
| 11 | receiving groove |
| 12 | positioning device |
| 13 | positioning element |
| 14 | gripping device |
| 15 | gripping element |
| 16 | outer circumference |
| 17 | circumferential direction |
| 18 | radial direction |
| 19 | axial direction |
| 20 | lever |
| 21 | guide groove |
| 22 | link |
| 23 | roller element |
| 24 | sleeve |
| 25 | sleeve shell surface |
| 26 | upper end area |
| 27 | positioning groove |
| 28 | guiding element |
| 29 | supporting device |
| 30 | supporting surface |
| 31 | groove ring |
| 32 | groove ring circumference |
| 33 | securement groove |
| 34 | pre-positioning device |
| 35 | lever guiding device |
| 36 | lever length |
| 37 | first lever arm |
| 38 | first rod section receiving portion |
| 39 | second lever arm |
| 40 | second rod section receiving portion |
| 41 | first rod section receiving portion axis |
| 42 | inner diameter |
| 43 | inner sleeve diameter |
| 44 | drive member |

1. A method for forming a conductor pack provided for inserting into a stator or rotor, comprising the following steps:
providing a plurality of substantially U-shaped conductor elements, each having a first rod section, a first conductor end, a second rod section, and a second conductor end, wherein the first rod section and the second rod section of each conductor element are connected by a substantially arc-shaped connection section;
receiving, at least in part, the first rod sections in receiving portions, wherein the receiving portions are formed along an outer circumference of an inner holding device;
pre-positioning the second rod sections by utilizing a positioning device to place a respective second rod section proximate a respective first rod section of another conductor element; and
gripping, with gripping elements of at least one gripping device circumferentially arranged around the inner holding device, rod section pairs each pair formed from a pre-positioned second rod section and a first rod section adjacent in a radial direction, the gripping elements guided in the radial direction towards the inner holding device;
wherein prior to pre-positioning of the second rod sections, the first rod sections are rotatably received in the receiving portions at least in part, and the second rod sections are arranged annularly in a free-standing manner around the outer circumference of the inner holding device and spaced apart from the outer circumference outwards in the radial direction, and, for pre-positioning, the second rod sections (6) are pressed by a positioning element of the positioning device, said positioning element being guided in the circumferential direction and simultaneously in the radial direction towards the outer circumference of the inner holding device, and
wherein the conductor elements are each rotated around a first rod longitudinal axis of the first rod sections, which are rotatably received in the receiving portions at least in part.

2. The method according to claim 1, wherein during the providing, receiving and pre-positioning, the conductor elements are each contacted at the first and the second rod sections by one lever, which is rotatably formed around the first rod longitudinal axis of the respective first rod sections, and wherein the lever, during the pre-positioning, guides the second rod sections in the circumferential and the radial directions through an inward pivotal movement, associated with the pressing movement of the second rod sections by the positioning element.

3. The method according to claim 1, wherein during the providing, receiving and pre-positioning, the conductor elements are each contacted at the second rod section by one guide groove of at least one link, and wherein during the pre-positioning of the second rod sections, the second rod sections are guided in the circumferential and radial directions by the positioning element.

4. The method according to claim 1, wherein the positioning element is formed by a roller element rotatably arranged at the positioning device, and wherein the roller element, during the pre-positioning of the second rod sections, rolls on the second rod sections or is actively driven to roll on the second rod sections.

5. The method according to claim 1, wherein the receiving portions for the first rod sections are formed by receiving grooves which are open outwards and run in the axial direction, and wherein the first rod sections are received in said receiving grooves at least in part, wherein, during the receiving of the first rod sections and during the pre-positioning of the second rod sections, a sleeve is arranged around the first rod sections at least in part, the sleeve directly adjacently surrounds the first rod sections outwards in the radial direction and, during the pre-positioning, secures the first rod sections against being displaced outwards in the radial direction.

6. The method according to claim 5, wherein the second rod sections are applied to an outer sleeve shell surface of the sleeve for the pre-positioning.

7. The method according to claim 5, wherein, after the pre-positioning of the second rod sections, the sleeve is shifted in the axial direction with respect to the inner holding device downward into an area of the second conductor ends of the second rod sections, and that afterwards, the second conductor ends of the pre-positioned second rod sections are pressed by the positioning element or the gripping elements of the gripping device into positioning grooves circumferentially arranged in an upper end area at the sleeve, wherein the positioning grooves open upwards.

8. The method according to claim 1, wherein in an area of the second conductor ends of the second rod sections, a guiding element with positioning grooves opening upwards is arranged, and wherein during the gripping process, the second conductor ends of the pre-positioned second rod sections are pressed into the positioning grooves by the gripping elements of the gripping device.

9. The method according to claim 1, wherein during the pre-positioning of the conductor elements, the first conductor ends of the first rod sections are supported in the axial direction by a supporting device having at least one supporting surface.

10. The method according to claim 9, wherein during the pre-positioning of the second rod sections, the first rod section of at least one of the conductor elements is mounted by at least one height-adjustable supporting surface of the supporting device in a height different from other conductor elements.

11. The method according to claim 1, wherein in an area of the first conductor ends of the first rod sections, a groove ring is arranged, wherein the groove ring has a circumference where securement grooves are arranged, the securement grooves opening outwards and vertical, and wherein the first conductor ends of the first rod sections are introduced into said securement grooves prior to the pre-positioning of the second rod sections.

12. A pre-positioning device for forming a conductor pack provided for inserting into a stator or rotor, comprising:
an inner holding device with receiving portions arranged along an outer circumference of the inner holding device and provided for receiving, at least in part, first rod sections with first conductor ends, the first rod sections of conductor elements having a substantially U-shape;
a positioning device for pre-positioning second rod sections with second conductor ends, the second rod sections of the conductor elements, wherein the second rod sections are connected to the first rod sections by a substantially arc-shaped connection section;
at least one gripping device having gripping elements, the at least one gripping device arrangeable around the inner holding device in a circumferential direction with the gripping elements adjustable in a radial direction towards the inner holding device, said gripping device being formed for gripping rod section pairs, each rod section pair formed from a pre-positioned second rod section and an adjacent, first rod section; wherein
the receiving portions are dimensioned such that the first rod sections are rotatably receivable in the receiving portions at least in part,
and the positioning device for pre-positioning the second rod sections comprises a positioning element spaced apart from the inner holding device outwards in the radial direction,
wherein the positioning element is circumferentially drivable in the circumferential direction of the inner holding device and simultaneously adjustable radially inwards.

13. The pre-positioning device according to claim 12, wherein a lever guiding device having a number of levers corresponding to the number conductor elements is formed, wherein the levers are bow-shaped with a predeterminable lever length and two lever arms, which are horizontally extended and point in the same direction, wherein the first lever arm comprises one respective first rod section receiving portion having a shape compatible with the first rod section of the conductor element, and wherein the second lever arm comprises one respective second rod section receiving portion having a shape compatible with the second rod section of the conductor element, and wherein the levers are each rotatably mounted around a first rod section receiving portion axis, which is aligned with a first rod longitudinal axis of the respective first rod sections, and wherein the levers are distributed in the circumferential direction and offset in the axial direction such that all levers are pivotable inwards in the circumferential direction.

14. The pre-positioning device according to claim 12, wherein a link having a number of guide grooves corresponding to the number of conductor elements is formed, wherein the guide grooves are arcuate, starting from an inner diameter facing the inner holding device and formed as openings penetrating the link in the axial direction, the circumferential direction, and the radial direction.

15. The pre-positioning device according to claim 12, wherein the positioning element is formed by a roller element rotatably arranged at the positioning device, wherein said roller element is rotatably mounted without a drive or operatively connected to a drive member for actively driven rotation.

16. The pre-positioning device according to claim 12, wherein the receiving portions for the first rod sections are formed by receiving grooves, which are open outwards and run in the axial direction, and wherein a sleeve is formed, which is arranged below the receiving grooves, wherein the sleeve has an inner sleeve diameter such that the sleeve forms a limitation for the first rod sections outwards in the radial direction.

17. The pre-positioning device according to claim 16, wherein the sleeve comprises positioning grooves arranged in an upper end area in the circumferential direction and the grooves open upwards, and wherein the positioning grooves are formed for receiving the second conductor ends of the second rod sections.

18. The pre-positioning device according to claim 12, wherein a guiding element with positioning grooves is formed, and wherein the positioning grooves are formed for receiving the second conductor ends of the second rod sections.

19. The pre-positioning device according to claim 12, wherein a supporting device having at least one supporting surface is formed, and wherein the supporting device is provided for axially supporting the first rod sections.

20. The pre-positioning device according to claim 19, wherein the supporting device comprises at least one height-adjustable supporting surface.

21. The pre-positioning device according to claim 12, wherein a groove ring having a groove ring circumference is formed, and wherein securement grooves are arranged at the groove ring circumference, the securement grooves opening outwards and vertical, the securement grooves formed for receiving, at least in part, the first conductor ends of the first rod sections.
